(19) United States
(12) Patent Application Publication
(10) Pub. No.: US 2015/0363883 A1
(43) Pub. Date: Dec. 17, 2015

(54) RESTRUCTURED CAPITAL APPRECIATION BONDS

(71) Applicant: Dale Scott & Company, San Francisco, CA (US)

(72) Inventor: Dale SCOTT, San Francisco, CA (US)

(21) Appl. No.: 14/741,171

(22) Filed: Jun. 16, 2015

Related U.S. Application Data
(60) Provisional application No. 62/013,442, filed on Jun. 17, 2014.

(51) Int. Cl. G06Q 40/06; G06Q 40/04

(52) U.S. Cl. CPC G06Q 40/06; G06Q 40/04

(57) ABSTRACT

A computer-implemented technique restructures a capital appreciation bond (CAB) by using market data among other data to offer an incentive to a current owner of the CAB to sell voluntarily his or her bond back to the school district that issued the bond. This resold CAB is, in turn, replaced with a restructured lower cost bond, i.e., a CAB restructured bond (CRB), through a particular refinancing, computer-implemented, process referred to as bond refunding.

### CROSS REFERENCE TO RELATED APPLICATIONS

This patent application claims priority from U.S. Provisional Patent Application Ser. No. 62/013,442, RESTRUCTURED CAPITAL APPRECIATION BONDS, filed Jun. 17, 2014, the entirety of which is incorporated herein by this reference thereto.

### BACKGROUND

In November 2000, California voters passed Proposition 39 (“Prop 39”), lowering the required voter approval rate for school district and community college district (“K-14”) general obligation bonds to 55% from the previous 66.7% threshold. Prior to the approval of this constitutional amendment, the state legislature enacted a number of regulations governing the issuance of bonds under Prop 39 should it pass.

Among these regulations was one imposing a tax rate limitation ($60 per $100,000 of assessed valuation for unified school districts, $30 for high school and elementary districts and $25 for community college districts) on bonds sold under Prop 39. However, the tax rate limitation (“cap”) was not a true tax rate cap or tax rate limit. Instead, districts seeking to issue bonds were required to provide assessed value growth projections showing how the future tax rates would not exceed the cap.

While there had been leeway taken in the underlying assumptions used to produce these projections, it remained that once a district had exceeded its tax rate cap, it was then unable to sell any additional bonds approved by the voters. For example, if a specific assessed valuation fell, then tax had to increase to cover the shortfall in revenue, which could cause the increased tax rate to exceed the tax rate cap.

Rather than simply wait for assessed valuations to grow, many districts sought alternative structures by which they could continue to issue bonds while not violating the tax rate limitation. A method used by many districts was to issue capital appreciation bonds (“CABs”). These bonds pay no interest for a set period of years, during which time interest accretes with its payment combined with the final repayment of the bond's principal.

Because these bonds were structured without interest payments in the earlier years, they could be issued even when a district had exceeded its tax rate limit in the earlier years. However, the vast majority of these bonds were issued as either non-callable bonds (“non-callable”), meaning the districts have no ability to refinance the bonds in future years into lower interest rates, or with a call date at some date in the future.

While in compliance with the tax rate requirements of Prop 39, the impact of deferring these payments made for some difficult outcomes. For example, one school district issued a bond which provided the district with about $100 million of funding. However, at end, the bond's total repayment cost was close to $1 billion. In another example, a community college district borrowed $4.6 million but may end up paying back nearly $60 million. Between 2006 and 2013, over 170 K-14 districts were found to have issued CABs with a debt repayment ratio of over 4:1.

A political firestorm caused by these bonds resulted in state legislation that limited the repayment ratio to no more than 4:1 and the terms, e.g. to 25 years down from 40 years. However, this legislation, effective Jan. 1, 2014, restricts CAB deals going forward and does not address prior financings.

### BRIEF DESCRIPTION OF THE DRAWINGS

One or more embodiments of the present disclosure are illustrated by way of example and not limitation in the figures of the accompanying drawings.

FIG. 1A provides a brief, general description of a representative environment in which the disclosed techniques can be implemented.

FIG. 1B is a high-level block diagram showing an example of the architecture for a computer system.

FIG. 2 a flow diagram illustrating a CAB restructured bond (CRB) process overview.

### DETAILED DESCRIPTION

### Restructuring Capital Appreciation Bonds Process Overview

A computer-implemented technique restructures a capital appreciation bond (CAB) by using market data among other data to offer an incentive to a current owner of the bond to sell voluntarily his or her bond back to the district which issued the CAB. This resold bond is, in turn, replaced with a restructured lower cost bond through a particular refinancing process referred to as bond refunding. This lower cost bond can be issued lawfully because the current state law does not subject a refunding bond to the same tax rate restrictions as the originally issued Prop 39 bond.

In an embodiment, the identification of a CAB involves sorting through a number of variables. A data base of these variables can be built using information from both the California Debt and Investment Advisory Commission's on-line data base and specific deal information available on-line on the Municipal Securities Rulemaking Board's EMMA (Electronic Municipal Marketplace Access) website. The built data base includes the following information regarding each CAB deal:

### a) Name of Issuer

b) Par amount of bonds issued
c) Accreted amount of bonds at a maturity
d) Date issued
e) Final maturity
f) Years bonds are outstanding
g) Debt ratio
h) Whether bonds are callable
i) If callable, year bonds can be called

Using this information the CAB restructured bond (CRB) process, system, and computer-readable medium embodiments (“system” or “technique”) make a quick determination of potential savings that can result from a CRB refunding and whether the district is a viable candidate for CRB refunding. If the bond is callable, the technique assumes a savings of roughly 75% of the difference between the accreted value of the bond and the original par amount of the bond issued. If non-callable, the assumed savings is set at 25%. For example, the Carmel Unified School District (USD) issued a $1.6 million non-callable CAB in 2008. The bond accretes to $2.6 million in 2033. The technique makes a calculation that if the technique could convert 25% of the CABs into current interest bonds (CIBs), the savings would be approximately $640,000. This calculation also makes an assumption as to how much the bond accreted from the time issued to the present day, e.g., today. At this level of savings, the CAB is determined not to be a candidate for CRB refunding.

In contrast, the Jefferson Union High School District issued $15 million of CABs in 2011 which accrete to $126.7 million in 2042. However, the bonds are fully callable in 2020. The potential savings from this CRB are computed to be in excess of $75 million.

Actions taken by the school board can be the same regardless of whether a bond is callable or not. In either case, the district determines the maximum amount of bonds it wishes to refinance from CABs into CIBs. For example, while a district might reap substantial savings by converting 100% of its CABs into CIBs, to do so would result in a significant and unpalatable increase in the current tax rate. As such, it may or may not wish to limit the refinancing to a certain percentage of outstanding CABs. Once this decision is made, there is a significant difference regarding how the technique approaches the transaction depending on whether the CABs are callable or non-callable.

For a bond that is non-callable, the technique first searches to find whether any of the issued non-callable bonds are available in the open market and saves this information. If such available bonds are below the threshold established by the district regarding the amount of bonds it wishes to refinance, certain owners of the CABs are identified based upon information available in the open market either through public sources such as published sources or through contact with market participants. These identified owners are contacted and an open market negotiation ensues to determine the price needed to be offered and paid to repurchase a bond. In an embodiment, again assuming contact with identified owners does not result in the refinancing threshold established by the district, a tender notice is published of the given district's desire to buy the bonds back at a mutually agreeable price. Once the established amount of CABs have been acquired or, if this established amount has not been reached but a reasonable period of time has passed, the acquired bonds are refunded with a CRB.

For a bond that is callable, the embodiment first performs an analysis comparing the potential savings from setting up an escrow to refund the bonds on the call date vs. attempting to purchase the bonds from current investors through any of the three methods described above. If carrying cost of the escrow is too high, these bonds are then treated as if non-callable and the method described above for refinancing callable bonds is used. If the refunding is financially advantageous, an escrow is created and the refunding process proceeds.

### A Representative Environment

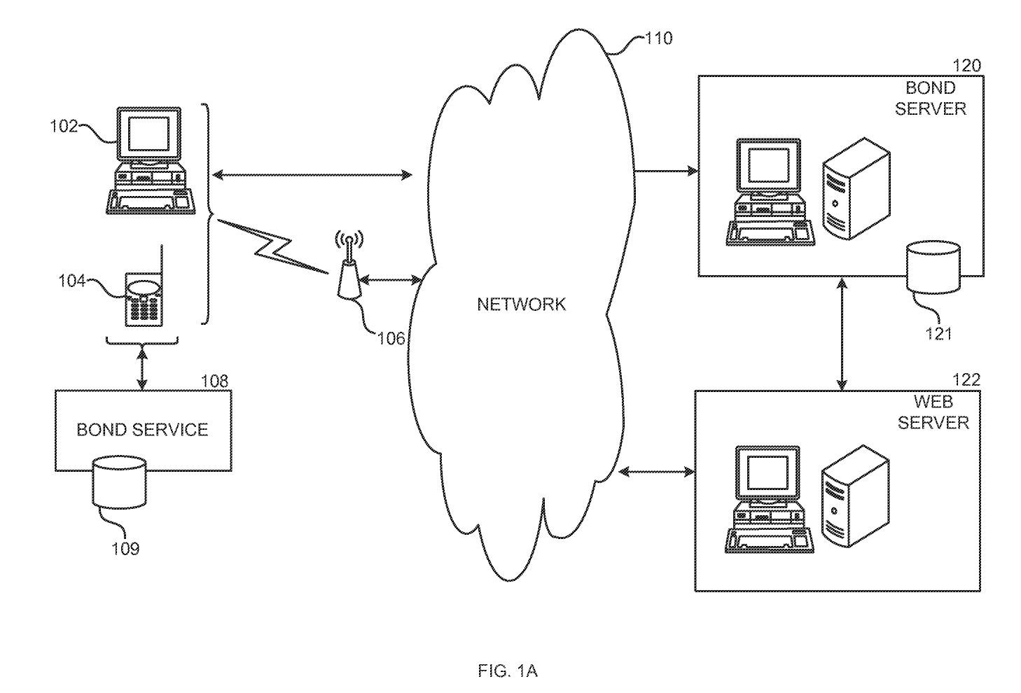

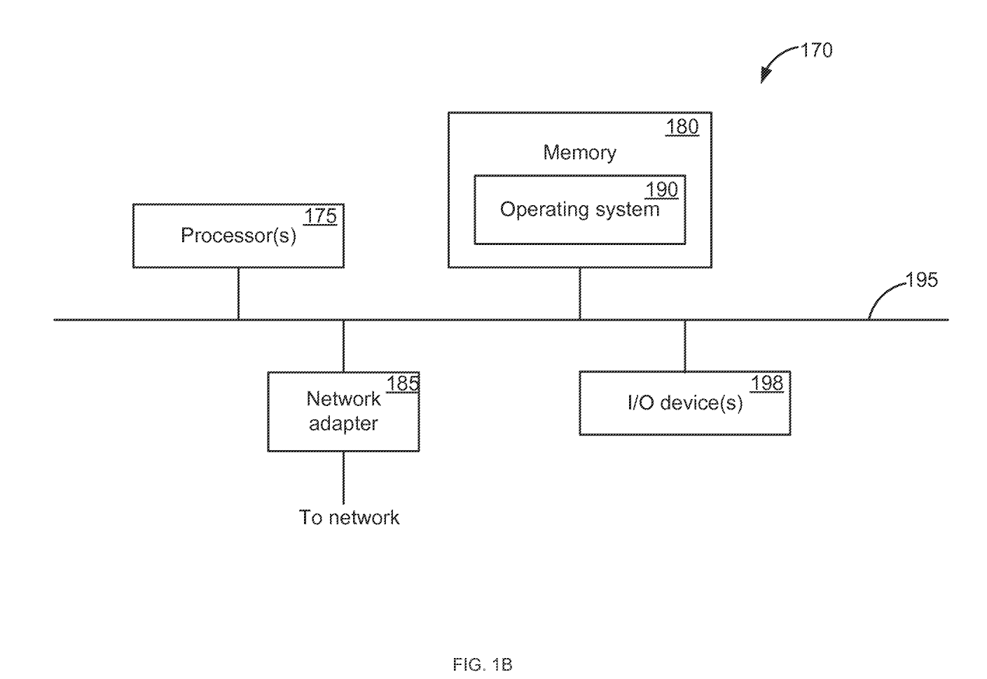

Techniques are described below for identifying a district having issued a CAB and in need of restructuring the CAB to lower the repayment. FIG. 1A and the following discussion provide a brief, general description of a representative environment in which the techniques described below can be implemented. Although not required, aspects of the disclosure may be described below in the general context of computer-executable instructions, such as routines executed by a general-purpose data processing device (e.g., a server computer or a personal computer). Those skilled in the relevant art will appreciate that the techniques can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the disclosure, such as certain functions, are described as being performed exclusively on a single device, the techniques can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the disclosure may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the disclosure may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1A, a user may use a personal computing device (e.g., a mobile computing device 104, a personal computer 102, etc.) to execute functionalities for the techniques described herein. The user may also use the personal computing device to communicate with a network. The term “mobile computing device,” as used herein, may be a laptop, a netbook, a personal digital assistant (PDA), a smart phone (e.g., a Blackberry®, an I-phone®, etc.), a portable media player (e.g., an IPod Touch®), or any other device having communication capability to connect to the network. In one example, the mobile computing device 104 connects to the network using one or more cellular transceivers or base station antennas (not shown in FIG. 1A), access points, terminal adapters, routers or modems 106 (in IP-based telecommunications implementations), or combinations of the foregoing (in converged network embodiments).

In some instances, the network 110 is the Internet, allowing the personal computing device to access functionalities offered through, for example, the compare server 120 or various web servers. In some instances, the network is a local network maintained by a private entity or a wide area public network, or a combination of any of the above types of networks. In some instances, especially where the mobile computing device 104 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

As shown in FIG. 1A, in some instances, the personal computing device may have a bond service 108 installed locally. In such instances, the user may use the personal computing device to submit requests to the bond service to identify a district that needs to restructure its CAB, generate and pass a resolution, generate details of a tender offer, publish the tender offer, forward the tender notice to a bond ownership clearing house, contact identified owners of a CAB, receive and convert a CAB, issue a CAB restructured bond (CRB), and sell the CRB to a joint powers authority or other investors. As will be explained in detail below, the bond service 108, running on the personal computing device, receives input information for a CAB restructure request and subsequently performs an analysis of suitable school districts and/or college districts for which a CAB restructure would be advantageous. In such an instance, the bond service 108 presents the school district and/or college district information to the user using a display unit of the personal computing device. Accordingly, the bond service 108 can run as a stand-alone service without requiring a connection to the network 110.

In some instances, the bond service is configured to run remotely on a bond server 120. In such an instance, the bond service is run similar to a web or internet service in conjunction with a web server 122. As explained above, a user may use a personal computing device to connect to the bond server 120 using the network (e.g., a local office network, the Internet, etc.). In an illustrative example of such an instance, the user would use the personal computing device to submit a CAB restructure request to the bond server. The bond server 120 receives the request and identifies a suitable school district and/or college district. Subsequently, the bond server 120 transmits the results of the restructuring to the personal computing device, which information is then displayed using a display unit of the personal computing device. In some instances, the bond server 120 may by itself operate as a web server to receive and transmit contents using standard web protocols. In other instances, the bond server 120 may be coupled to a web server 122, where the bond server performs the various bond-related services, while the web server enables the transmission and reception of data using standard web protocols.

The bond service 108 can access a local database(s) 109 that contains information needed by the bond service, for example, size of original transactions of the district, debt ratio (i.e., total debt service divided by original principal), length of an amortization period, and potential savings. In some instances, the database(s) 109 is accessed over the network 110. Similarly, the bond server 120 can either access a local database 121 containing the above information or access the database over the network 110. Each of the databases 109/121 can include a single database or multiple separate databases.

### An Example Machine Overview

FIG. 1B is a high-level block diagram showing an example of the architecture for a computer system 170 that can be utilized to implement a personal computing device (e.g., 102 from FIG. 1A) for running a bond service, a bond server 120, or a web server (e.g., 122 from FIG. 1A), etc. In FIG. 1B, the computer system 170 includes one or more processors 175 and memory 180 connected via an interconnect 195. The interconnect 195 is an abstraction that represents any one or more separate physical buses, point to point connections, or both connected by appropriate bridges, adapters, or controllers. The interconnect 195, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 175 may include central processing units (CPUs) to control the overall operation of, for example, the host computer. In certain embodiments, the processor(s) 175 accomplish this by executing software or firmware stored in memory 180. The processor(s) 175 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 180 is or includes the main memory of the computer system 170. The memory 180 represents any form of random access memory (RAM), read-only memory (ROM), flash memory (as discussed above), or the like, or a combination of such devices. In use, the memory 180 may contain, among other things, a set of machine instructions which, when executed by processor 175, causes the processor 175 to perform operations to implement embodiments of the present disclosure.

One or more input/output (I/O) devices 198 can include a keyboard, mouse, touch screen or other touch input device, a display, and speakers. Also connected to the processor(s) 175 through the interconnect 195 is a network adapter 185. The network adapter 185 provides the computer system 170 with the ability to communicate with remote devices, such as storage clients, and/or other storage servers, and may be, for example, an Ethernet adapter or Fiber Channel adapter.

### An Exemplary CRB Restructuring Bonds Process

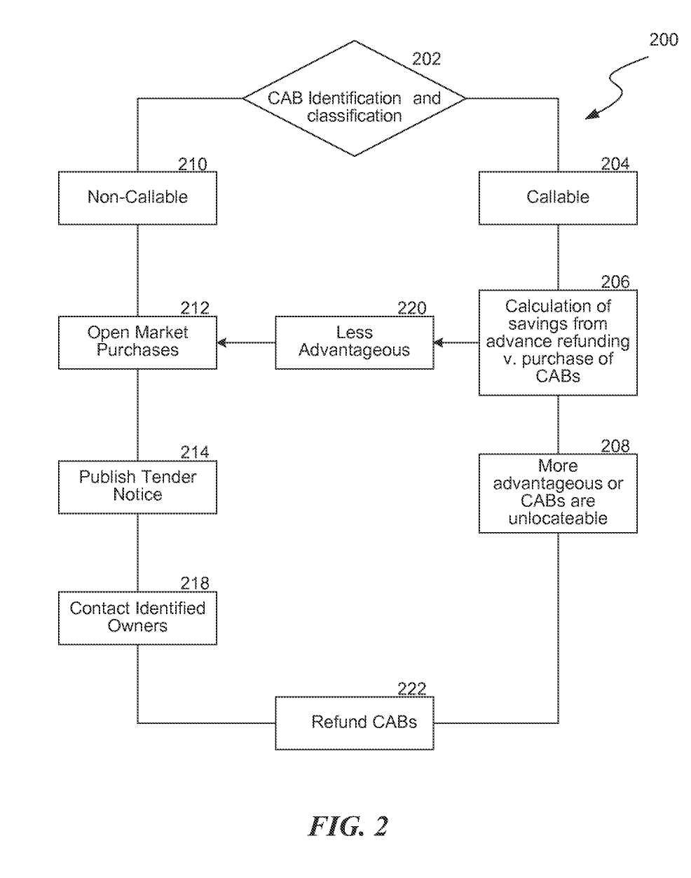

An exemplary innovative process to replace a district's CAB with a CRB, which is issued as a refunding bond, is described in details as follows. The CRB process can be understood with reference to FIG. 2, a CRB Restructuring Bonds Process Overview 200. It should be appreciated that while the exemplary embodiment is described with reference to a CRB process, a machine, e.g. system, to perform the process and a non-transitory computer-readable medium on which to store instructions for performing the process on the computer are considered described herein as well. It further should be appreciated that although the innovation is described herein with reference to a particular embodiment, one skilled in the art will readily appreciate that other applications may be substituted for those set forth herein without departing from the spirit and scope of the present innovation.

### CAB Identification and Classification

In an embodiment, a first step in the General Obligation (“GO”) Bond CAB Restructuring Bond (“CRB”) process is to identify and classify likely CAB candidates 202. While there are hundreds of California school district and community college (“K-14”) district CAB financings outstanding, the CRB process is applied to those deals where significant taxpayer savings may result.

Working off an in-house database of K-14 CAB deals, an embodiment first determines the debt ratio of each financing. This is calculated by dividing the total debt service of each issue (the accreted value of the bond at maturity) by the original par amount of bonds issued. So, for example, if a district issued $25 million of CABS in 2008 with a final total payment in 2038 of $125 million, the debt ratio would be 5 to 1.

In 2013, the California State legislature passed (and the Governor signed) AB 182. Effective Jan. 1, 2014, AB 182 placed certain limitations on K-14 GO CABs. Among these was a provision that the debt ratio of any GO CAB financing that closed after Jan. 1, 2014 could be no greater than 4 to 1.

For this reason, our first screen of the CAB deal data is to identify K-14 GO CAB deals with debt ratios equal to or greater than 4 to 1. Although this ratio is arbitrary, in an embodiment, such ratio is reasonable given that the State has restricted CAB deals issued after Jan. 1, 2014 with debt ratios of greater than 4 to 1. One skilled in the art would readily recognize that other ratios can be applied and that 4 to 1 can be considered a particular implementation.

For those CAB deals with debt ratios equal to or greater than 4 to 1, a second screen is applied in order to divide the transactions into two groups: a) those that can be called (refinanced) at some future date and b) those that are non-callable. In an embodiment, the callability of a CAB deal determines how the CRB program is implemented, as discussed in detail below.

### Estimating Potential Savings

Each CAB financing has a multitude of variables that affect the potential savings from the CRB program. For example, District A issued a $10 million CAB in 2008 with an 8% accreted rate of interest. District B issued a $10 million CAB in 2012 with a 6% accreted rate of interest.

The CRB refunding process requires that new bonds be issued to refund the current market value of an outstanding CAB. In this example, the current market value, and thus the potential savings, of the two CABs are quite different. District A's CAB has been accreting at a high rate of interest for six years. In addition, since comparable interest rates in today's market are lower, the market price of the bond would have risen. District B's CAB, on the other hand, has only been accreting for two years and at a lower rate of interest. In addition, its interest rate is close to current market rates and therefore would have had less increase in value.

In an embodiment, to calculate the potential savings that result from a CRB refunding, the following data are acquired and used:
The accreted value of the bond at maturity;
The accreted value of the bond as of today;
The change in the price of the bond given current interest rates;
Any premium that would need to be paid in order to acquire the bond from the current owners;
The interest costs associated with the refunding bond; and
Costs of issuance.

However, given the large amount of research and time required to compute the potential savings of each individual CAB, an embodiment instead applies broad based assumptions for a first cut in attempting to identify potential savings.

### Computing Estimated Savings on Callable CABs

An embodiment computes estimated savings on callable CABs 206. For callable bonds, the embodiment subtracts an amount equal to the CAB's original principal times 2.5 from the accreted value of the CAB at maturity (accreted value−(original par×2.5)). The 2.5× multiplier is determined based on empirical evidence from a randomly chosen small sample of different types of CABs and calculating an average of the factors listed above. It should be appreciated that the specific multiplier is by way of example only and one skilled in the art would readily recognize one or more different multipliers in the technique.

For example, Jefferson HSD issued a $15 million CAB in 2011 which accretes to $127 million by 2042. In order to determine a rough estimate of the potential savings, the embodiment takes the par value of the CAB ($15 million) times 2.5 ($37.5 million) and subtract this amount from the accreted value of the CAB ($127 million) for a potential gross savings of $89.5 million.

However, even though this bond is callable, the bonds cannot be replaced until 2020. For this reason, an embodiment structures the refinancing as an advance refunding. This is done by borrowing money in today's market and then placing the funds into an escrow that remain in place until 2020. Such step may lead to significant negative arbitrage since the funds in the escrow may be earning at a rate far below the borrowing costs.

Calculating the actual cost of each CAB's escrow is also time-consuming. Thus, for this first cut analysis, an embodiment assumes 25% of the gross savings is consumed by negative arbitrage resulting with estimated net savings to be 75% of the gross. This number may be considered an average of escrow costs for the computation of the escrow cost for the plurality of CABs included in the study. In the case of Jefferson HSD, such process results in potential net savings (before costs) of $67.125 million.

### Computing Estimated Savings on Non-Callable CABs

The process for calculating potential savings for non-callable CABs is similar to that for callable CABs. However, since the bonds cannot be called, there is no need to apply a factor for the cost of the escrow.

However, this lack of callability may greatly decrease the potential for obtaining bonds for refunding, as described below. Here, an embodiment assumes net savings for non-callable bonds to be 25% of gross savings. One skilled in the art would readily appreciate that the value, 25%, is by of example only and is not limiting. One skilled in the art can arrive at a different value percent of gross savings. For example, in an embodiment. such number can be arrived at after consultation with investment bank/underwriters with experience in this field.

### Implementation—Callable CABS

In an embodiment, when implementing the CRB program with a specific district, the cost and potential savings computations can be based on the actual numbers for the specific financing. For callable bonds, an embodiment computes the actual cost of constructing an escrow and the potential savings that would result from an advance refunding of the bonds. To perform such computation, an embodiment may use a licensed software program, such as for example DBC® Finance (by SS&C Technologies, Inc., Windsor, Conn.), specifically designed to assist with the construction of municipal bond advance refundings.

In an embodiment, a user may consult with industry experts to estimate the potential savings that would result from buying the bonds from the current owners at the market rate. In an embodiment, such industry experts may also advise the user as to whether a premium might be desirable to purchase the bonds and, if so, the amount of the premium and the reasonableness of this amount.

The potential savings from these two methods is then compared. If the savings are greater from an advance refunding, the embodiment does not attempt to acquire bonds from the current owners but rather begins the process of setting up the escrow to refund the bonds.

If, however, the acquisition of the bonds through the CRB program produces more savings 208, the embodiment initiates the CRB process as described below. It should be appreciated that both methods may actually be used on any particular transaction. For example, even though it may be more advantageous to implement the CRB program than to advance refund the bonds, only a portion of the bonds might be available for acquisition. In this case, those bonds that are not refunded through the CRB program could still be advance refunded.

### Implementation—CRB Program

The process for bonds that are either non-callable 210 or, though callable, are more advantageous if acquired through the CRB program 220, is as follows.

A. Authorization, e.g., Passage of District Resolution. Authorization is established for the sale of GO refunding bonds, authorizing an underwriter to acquire outstanding CABs, as described in greater detail below. In an embodiment, the refunding bonds may be sold to a particular entity for processing. As an example, the Board of Trustees of a particular district passes a resolution authorizing the sale of GO Refunding Bonds and directing an appointed underwriter to acquire outstanding CABs as described below. The resolution may also authorize that the Refunding Bonds be sold to a Joint Powers Authority (“JPA”) at the discretion of the District administration.

B. Open Market Purchases 212. Regardless of whether a bond is callable or non-callable, owners may be looking to sell the bonds in the secondary market. The district's underwriter is directed to determine if any such bonds are available and, if so, acquire them at the market price. Any bonds acquired by this method are held by the underwriter on behalf of the district.

C. Privately Negotiated Secondary Market Transactions. Certain owners of the CABs, e.g., institutional buyers, can be identified through generally available market data sources. These owners are contacted individually and asked if they are interested in selling. In an embodiment, these are one-on-one negotiations that seek to determine what price is desired to be offered to repurchase the bonds and if such a price is advantageous. Any bonds acquired by this method are held by the underwriter on behalf of the district.

D. Tender Notice. The district may also publish and distribute a tender notice 214 to all bond owners 218 stating indicating the district's desire to buy the bonds back at a mutually agreeable price. Any bonds acquired by this method are held by the underwriter on behalf of the district. It should be appreciated that using a tender notice is according to an embodiment and one skilled in the art would readily appreciate that such technique is not meant to be limiting. In an embodiment, a tender notice may not be required.

E. Sale of the CRBs. At a pre-determined point, e.g. typically less than one month, the underwriter, who now owns the acquired CABs, agrees to a request from the district to make these CABs callable. The district then issues GO Refunding Bonds 222. These bonds are either sold into the public marketplace by the underwriter or sold the to JPA. If sold to the JPA, the JPA aggregates the bonds with other districts' CRBs and sells a single issue of GO Revenue Refunding Bonds through the underwriter into the general market.

### CONCLUSION

As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. Accordingly, the applicant reserves the right to add additional claims after filing the application to pursue such additional claim forms for other aspects of the invention.

We claim:

1. A computer-implemented method for restructuring a capital appreciation bond (CAB), comprising:
identifying and classifying a CAB candidate;
estimating potential savings from said restructuring said CAB candidate, using:
an accreted value of said CAB candidate at maturity;
an accreted value of said CAB candidate as of current day;
a change in a price of said CAB candidate using current interest rates;
a premium, when used to acquire said CAB candidate from one or more owners;
interest costs associated with an associated refunding bond; and
cost of issuance of said refunding bond; and
issuing said refunding bond;
wherein one or more steps are performed on at least a processor coupled to at least a memory.

2. The method of claim 1, wherein said CAB candidate is classified as callable and further comprising:
computing an estimated savings on said CAB candidate by subtracting an amount equal to an original principle value of said CAB candidate multiplied by a predetermined factor from an accreted value of said CAB candidate at maturity.

3. The method of claim 2, wherein said predetermined factor is 2.5.

4. The method of claim 2, further comprising structuring refinancing as an advance refunding by borrowing money in the current market and placing the borrowed funds into an escrow that remains in place until a called date.

5. The method of claim 2, wherein it is assumed that 25% of gross savings is consumed by negative arbitrage resulting with an estimated net savings being 75% of the gross.

6. The method of claim 1, wherein said CAB candidate is classified as non-callable and further comprising:
assuming a net savings to be 25% of gross savings.

7. The method of claim 1, wherein said CAB candidate is classified as non-callable and further comprising:
determining a net savings after consultation with investment bank/underwriters with relevant experience.

8. A computer-implemented method for restructuring a capital appreciation bond (CAB) for a particular district, comprising:
computing an actual cost of constructing an escrow account;
computing a potential savings resulting from an advance refunding of a plurality of capital appreciation bonds, comprising consulting with industry experts to estimate said potential savings resulting from buying said plurality of capital appreciation bonds from current owners at a market rate, wherein said industry experts provide advice as to whether a premium is desirable to purchase said capital appreciation bonds and, if so, the amount of the premium;
comparing said computed actual cost and said computed potential savings; and
when savings are greater from said advance refunding, not acquiring said capital appreciation bonds from said current owners and beginning process of setting up an escrow account to refund said capital appreciation bonds;
otherwise, initiating restructuring said capital appreciation bonds.

9. A computer-implemented method for restructuring a capital appreciation bond (CAB) for capital appreciation bonds for a particular district, comprising:
authorizing an underwriter to acquire outstanding CABs and to sell said acquired bonds to a joint powers authority (JPA);
directing said underwriter to acquire said outstanding CABs at a market price;
privately negotiating secondary market transactions for said outstanding CABs;
publishing and distributing, by said particular district, a tender notice to owners of said CABs, said notice indicating said district's desire to buy bonds back at a mutually agreeable price; and
at a pre-determined point in time, in response to said underwriter agreeing to a request from said district to make said CABs callable into restructured CABs (CRBs), selling said CRBs into the public marketplace or selling said CRBs to said JPA, wherein when sold to said JPA, said JPA aggregating said CRBs with other districts' CRBs and selling a single issue of general obligation revenue refunding bonds through the underwriter into the general market.

10. A computer-readable medium encoded with processing instructions for implementing a method performed by a computer, the method comprising:
identifying a district based on criteria for data comprising size of original transaction, debt ratio, length of amortization period, and potential savings, wherein the district had issued a capital appreciation bond (“CAB”);
generating a repurchase price for the CAB by determining a current market price for the CAB, generating a premium value, and combining the current market price and the premium value; and
after the CAB is repurchased at the repurchase price, converting the CAB to a CAB bond (“CRB”), wherein the CRB is configured to be callable at a tender price and wherein the tender price is a function of an accreted value of the bond, any adjustments based on current market conditions, and the premium.

11. An apparatus for restructuring a capital appreciation bond (CAB), comprising:
at least one processor operable to execute computer program instructions; and
at least one memory operable to store computer program instructions executable by said at least one processor, for performing:
identifying and classifying a CAB candidate;
estimating potential savings from said restructuring said CAB candidate, using:
an accreted value of said CAB candidate at maturity;
an accreted value of said CAB candidate as of current day;
a change in a price of said CAB candidate using current interest rates;
a premium, when used to acquire said CAB candidate from one or more owners;
interest costs associated with an associated refunding bond; and
cost of issuance of said refunding bond; and
issuing said refunding bond.

12. The apparatus of claim 11, wherein said CAB candidate is classified as callable and said computer program instructions further comprising:
computing an estimated savings on said CAB candidate by subtracting an amount equal to an original principle value of said CAB candidate multiplied by a predetermined factor from an accreted value of said CAB candidate at maturity.

13. The method of claim 12, wherein said predetermined factor is 2.5.

14. The method of claim 12, said computer program instructions further comprising structuring refinancing as an advance refunding by borrowing money in the current market and placing the borrowed funds into an escrow that remains in place until a called date.

15. The method of claim 12, wherein it is assumed that 25% of gross savings is consumed by negative arbitrage resulting with an estimated net savings being 75% of the gross.

16. The method of claim 11, wherein said CAB candidate is classified as non-callable and said computer program instructions further comprising:
assuming a net savings to be 25% of gross savings.

17. The method of claim 11, wherein said CAB candidate is classified as non-callable and said computer program instructions further comprising:
determining a net savings after consultation with investment bank/underwriters with relevant experience.
